(19) United States
(12) Patent Application Publication
(10) Pub. No.: US 2018/0219700 A1
(43) Pub. Date: Aug. 2, 2018

(54) Methods and Devices for Resetting a Radio Receiver Channel Estimate

(71) Applicant: Telefonaktiebolaget LM Ericsson (publ), Stockholm (SE)

(72) Inventors: Magnus Åström, Lund (SE); Fredrik Nordström, Lund (SE)

(21) Appl. No.: 15/521,818

(22) PCT Filed: Jul. 8, 2016
(86) PCT No.: PCT/EP2016/066275

§ 371 Date: Apr. 25, 2017

(51) Int. Cl. H04L 25/02; H04B 7/0456; H04L 5/00

(52) U.S. Cl. CPC H04L 25/0202; H04B 7/0456; H04W 24/10; H04L 5/0048; H04L 5/0035

(57) ABSTRACT

The disclosure relates to methods, devices, and computer programs in mobile communications. More specifically, the proposed technique relates to estimating channels using measurement signals transmitted by the network for use by wireless devices. In particular the disclosure relates to enabling efficient estimation of channels using such measurement signals. The disclosure relates to a method, performed within a radio access node in a wireless communication network, for facilitating channel estimation in a receiving wireless device. The method comprises determining (S1) that a change in a transmission setup within the radio access node is going to take place, sending (S2) an instruction to the receiving wireless device about the determined change in the transmission setup, and performing (S3) the change in the transmission setup at the radio access node.

### TECHNICAL FIELD

The disclosure relates to methods, devices, and computer programs in mobile communications. More specifically, the proposed technique relates to estimating channels using measurement signals transmitted by the network for use by wireless devices. In particular the disclosure relates to enabling efficient estimation of channels using such measurement signals.

### BACKGROUND

The 3rd Generation Partnership Project, 3GPP, is responsible for the standardization of the Universal Mobile Telecommunication System, UMTS, and Long Term Evolution, LTE. The 3GPP work on LTE is also referred to as Evolved Universal Terrestrial Access Network, E-UTRAN. LTE is a technology for realizing high-speed packet-based communication that can reach high data rates both in the downlink and in the uplink and is thought of as a next generation mobile communication system relative to UMTS. In order to support high data rates, LTE allows for a system bandwidth of 20 MHz, or up to 100 MHz when carrier aggregation is employed. LTE is also able to operate in different frequency bands and can operate in at least Frequency Division Duplex, FDD, and Time Division Duplex, TDD, modes.

In an UTRAN and an E-UTRAN, a User Equipment, UE, i.e. a wireless device, is wirelessly connected to a Radio Base Station, RBS, commonly referred to as a NodeB, NB, in UMTS, and as an evolved NodeB, eNodeB or eNB, in LTE. A Radio Base Station, RBS, or a radio access node is a general term for a radio network node capable of transmitting radio signals to a UE and receiving signals transmitted by a UE. In Wireless Local Area Network, WLAN, systems the wireless device is also denoted as a Station, STA.

Traditional wireless communications rely on communications between a single base station e.g., an eNodeB, and multiple wireless devices. In order to properly demodulate the receive signals, à priori known reference or pilot signals are embedded among data in order to provide channel information to the receiver. Changing cells involves a handover procedure where the wireless device is given significant time to adjust to the new transmitter, e.g., receiving cell specific reference signals for proper channel estimation.

Co-ordinated multipoint, CoMP, where multiple eNodeBs communicate with the wireless device is one function that was introduced in 3GPP release 10. In future heterogeneous cellular systems, it is likely that even less distinction between cells and transmission points will exist. The 5th generation of cellular systems, sometimes referred to as 5G, takes the seamlessness of TM10 one step further. Also, the concept of one transmission point, one cell, is becoming less distinct. However, this will also put new requirements on the wireless device in terms of realizing which transmission is being used, and consequently knowing the channel response from that transmission point, in order to accurately be able to demodulate received signals.

Sounding Reference Signal, SRS, are reference signals used in LTE uplink, to estimate uplink channel quality, which allows eNodeB to take smart decisions for resource allocation for uplink transmission, link adaptation and to decode transmitted data from UE. The SRS allows eNodeB to take smart decisions for resource allocation for uplink transmission, link adaptation and to decode transmitted data from UE. SRS state channel quality of the frequency region in which uplink data is being transmitted. It is also used for estimating the downlink channel when the eNB can assume channel reciprocity.

In 3GPP release 10, user specific DeModulation Reference Symbols, DMRS, were introduced. DMRS is a reference signals used in LTE downlink, to estimate downlink channel. DMRS allow UE to both estimate the downlink channel and also estimate different channel state parameters such as Doppler spread, Delay spread, SNR, fine time and frequency errors etc.

From a performance perspective it is highly desirable to perform inter-subframe filtering of the reference signals from which channel estimates are derived, in order to increase the estimate processing gain, where a high processing gain means a larger suppression of noise and interference. This property becomes even more important with higher modulation orders, due to the more narrowly spaced constellation points, and/or with higher ranks, since the channel estimation errors grow with the number of estimated parameters.

However, it is also important to be able to change transmission setup both rapidly and flexibly, in order to provide the best possible performance at all times. Transmission setup here refers to precoder, transmission point(s), and other things that have an impact on whether the channel will be seen as “smooth” and continuous without any fast amplitude or phase changes at the wireless device if it is changed.

One problem with inter-subframe filtering is that when a transmission setup change occur, the wireless device that is performing inter-subframe filtering is likely to have lower performance. Since wireless devices use both temporal and spectral filtering to produce its channel estimate, it takes time in order for the wireless device to have obtained an equally good channel estimate for the new transmission setup compared to the old one. Therefore, in LTE release 9 and 10 inter-subframe filtering is sometimes avoided in order to allow for flexible scheduling at the eNodeBs.

Furthermore, in future 5G systems what traditionally is referred to as a cell may in 5G be several transmission points and frequent switching may occur between them. Additionally, 5G is lacking the fixed Cell Reference Signal, CRS, structure of LTE in order to become leaner in terms of power and less inter-cell interference. Consequently, in these systems there will also exist little opportunity for a wireless device to a priori perform channel estimation on a new transmission point, or even for the wireless device to realize it is being served from a new transmission point. Inter-subframe channel estimating filtering will provide more accurate and less noisy channel estimates. It will also reduce the need of extrapolating channel estimates at subframe edges, which will both give less biased and less noisy channel estimates.

Hence, there is a need for improved methods of facilitating channel estimation in wireless devices in combination with changes in transmission setup within the radio access nodes.

### SUMMARY

An object of the present disclosure is to provide methods and devices configured to execute methods and computer programs which seek to mitigate, alleviate, or eliminate one or more of the above-identified deficiencies in the art and disadvantages singly or in any combination.

This object is achieved by a method, performed within a radio access node in a wireless communication network, for facilitating channel estimation in a receiving wireless device. The method comprises determining that a change in a transmission setup within the radio access node is going to take place, sending an instruction to the receiving wireless device about the determined change in the transmission setup, and performing the change in the transmission setup at the radio access node. The method allows for using channel estimation filtering also in communication systems with transmission setup changes. Hence, one advantage is a more efficient handling of changing transmission setups and channel estimation in a heterogeneous network. This, in turn, will allow for higher transmission rates and less problematic moving between transmission setups and more efficient transmission in case of no transmission changes.

According to some aspects, the radio access node is configured to transmit data from multiple transmission points, and wherein the determined change in transmission setup comprises a change in transmission point setup within the radio access node. By informing the wireless device about a change in transmission points used for the transmission, the wireless device may update its channel estimation e.g. Channel estimates, the channel estimation filters, channel estimator, accordingly. Thereby, performance may be increased.

According to some aspects, the determined change in transmission setup comprises a change in precoder at the radio access node. By informing the wireless device about a change in transmission points used for the transmission, the wireless device may update its channel estimation settings accordingly. Thereby, performance may be increased.

According to some aspects, the instruction comprises at least one of: an indicator indicating that a change will take place and information about the change. An indicator is a simple solution requiring limited signaling. On the other hand if e.g., information about which transmission points will be used is also included, the wireless device may update its channel estimate with more accuracy.

According to some aspects, the method comprises measuring and evaluating channel conditions. Then, the determining comprises determining that a change in a transmission setup within the radio access node is going to take place, based on the evaluation. Evaluating channel conditions is a simple way to determine that a change in a transmission setup within the radio access node needs to take place.

According to some aspects, the instruction is sent through a control channel the instruction is sent as a message. It may also be sent on a layer higher than the control channel. According to some aspects, the instruction comprises one or more change bits and/or one or more of the least significant bits of a change counter. Hence, in principle only one control bit is needed to send the instruction.

According to some aspects, performing the change comprises at least one of activating or deactivating one or more transmission points within the radio access node and changing precoder in the radio access node. By sending an instruction to the device before such changes take place, the wireless device can adapt its behavior accordingly.

According to some aspects, the disclosure relates to a method, performed in a receiving wireless device in a wireless communication network, for channel estimation. The method comprises receiving an instruction from a radio access node that a change in transmission setup within a radio access node is going to take place, updating channel estimates and/or channel filter states and/or channel estimation filter coefficients at the receiving wireless device at the receiving wireless device based on the received instruction, and receiving data from the radio access node using the updated channel estimates.

According to some aspects, the disclosure relates to a radio access node, in a wireless communication network, configured for facilitating channel estimation in a receiving wireless device. The radio access node comprises a radio communication interface, and processing circuitry. The processing circuitry is configured to cause the radio access node to determine that a change in a transmission setup within the radio access node is going to take place, to send an instruction to the receiving wireless device about the determined change in the transmission setup, and to perform the change in the transmission setup at the radio access node.

According to some aspects, the disclosure relates to wireless device in a wireless communication network, configured for channel estimation. The wireless device comprises a communication interface and processing circuitry. The processing circuitry is configured to cause the wireless device to receive, using the communication interface, an instruction from a radio access node that a change in transmission setup within a radio access node is going to take place, to update channel estimates and/or channel filter states and/or channel estimation filter coefficients at the receiving wireless device at the receiving wireless device based on the received instruction, and to receive data using the updated channel estimates.

According to some aspects, the disclosure relates to computer program comprising computer program code which, when executed, causes a radio access node to execute the methods described above and below.

According to some aspects, the disclosure relates to computer program comprising computer program code which, when executed, causes a wireless device to execute the methods described above and below.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1a-1c illustrate different transmission modes in a radio access node.

FIG. 2 is a flow chart that illustrates the method steps performed in a radio access node according to some aspects of the present disclosure.

FIG. 3 is a flow chart that illustrates the method steps performed in a wireless device according to some aspects of the present disclosure.

FIG. 4 is an example node configuration of a radio access node, according to some of the example embodiments; and

FIG. 5 is an example node configuration of a wireless device, according to some of the example embodiments.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise. As discussed above less distinction between cells and transmission points in 5G is likely to cause decreased performance in wireless devices, due to lack of accurate channel knowledge in connection with changes in transmission setup. Therefore, this disclosure proposes a signaling method where a wireless device is instructed by its transmission point to change its channel estimates due to a change in transmitter setup.

For better understanding of the proposed technique MIMO precoding will now be described in more detail. In spatial multiplexing, multiple transmitter and receiver antennas are combined in order to resolve the spatially separated transmission paths. In order to manipulate the different paths to increase channel performance, precoding is used. A precoder is simply a way to shift the phases between the signals of a certain transmitter, TX, antenna and for a specific layer in order for the different signals to be constructively combined at the receiver. In earlier versions of LTE the allowed set of precoders was limited to and could thus be handled by a codebook. A simple model of a transmitted signal x, a received signal y, a MIMO channel H, a precoder W and additive noise w is:

y=HWx+w=H_{eff}x+W

where H_{eff} denotes the effective channel, i.e., the combined channel and precoder. From the equation it is obvious that a change either in H or in W will appear at the receiver as a change in the effective channel. Hence, when either changing the precoder or the channel, the existing channel estimates need to be replaced with new ones in order for the wireless device to properly demodulate x.

As mentioned above, wireless devices use so called pilots or reference signals for channel estimation. From a performance perspective it is highly desirable to perform inter-subframe filtering of the pilots or reference signals from which channel estimates are derived, in order to increase the channel estimate processing gain.

Inter-subframe channel estimating filtering of the pilots or reference symbols will provide more accurate and less noisy channel estimates. It will also reduce the need of extrapolating channel estimates at subframe edges, which will both give less biased and less noisy channel estimates.

There are different types of filtering that can be applied. One alternative, when doing the filtering in the frequency domain is first do filtering in the frequency direction and then filtering in the time direction. Typical filters for these operations are Finite Impulse Response, FIR, and Infinite impulse response, IIR, filters. If inter-subframe filtering is used the filtering in time direction can use the pilots from previous subframes. Another alternative of doing channel estimation filtering is to transfer coarse channel estimates, which have not been filtered yet, to time domain by an Inverse Fast Fourier Transform, IFFT. The signal after the IFFT can then be seen as noisy channel taps. These channel taps can then be filter by applying an FIR or IIR filter, possibly using estimates of channels taps from previous subframes. The filtered channel taps are then processed by a FFT which will give channel estimates in frequency domain.

The filter parameters, i.e. the coefficients used in the IIR and FIR filters are determined by Channel State Information, CSI, parameters. Examples of CSI parameters are Delay Spread, Doppler Spread, Signal to Noise Ratio, SNR, fine time and frequency errors. For example, a high Delay Spread implies a smaller channel coherence bandwidth. This means that, frequency-wise, distant DMRS symbols from the current time-frequency estimation position should have less influence on the estimation. Further, a large Doppler spread implies a smaller channel coherence time. This means that DMRS symbols that are, timewise, distant from the current time-frequency estimation position should have less influence on the estimation. Furthermore, a high SNR will result in lower influence of distant DMRS symbols in both frequency and time directions. The CSI can be estimated by either DMRS or other reference signals that also reflect the same transmission setup in the sense of the CSI parameter that is estimated.

Within this disclosure, such a filter is referred to as a channel estimation filter, and the process of filtering the reference symbols, e.g., DMRS, is referred to as channel estimation filtering.

3GPP introduced Transmission mode 9, TM9, and Transmission Mode 10, TM10, in releases 10 and 11 of LTE, respectively. In LTE Release 9, user specific demodulation reference symbols, DMRS, were introduced, allowing for arbitrary precoding of up to eight layers and removing the need for explicit precoder knowledge at the wireless device. Since DMRS is applied prior to the precoding step in the transmitter, the wireless device will not be able to separate W and H above, but is only able to distinguish H_{eff}. Hence, one thing that is distinguishing transmission modes 9 and 10 from earlier transmission modes is the use of these user specific reference signals. These reference signals differ from Cell Specific Reference Signals, CRS, in that are injected after precoding, in that they are injected prior to precoding, contrary to CRS:s. As an effect of this, from a UE perspective, changing a precoder results in a changed effective channel for transmission of DMRS in TM 9/10.

In addition, TM10 introduced coordinated multipoint, CoMP, transmissions. Several different CoMP varieties exist, the most relevant ones for this invention being:
i. Dynamic Point Selection, DPS, i.e., switching transmission point between several transmission points for a certain wireless device;
ii. Joint Transmission, JT, in which several transmission points transmit to a certain wireless device simultaneously;
iii. Coordinated Link Adaptation, CoLA, where the link is adapted, taking into account multiple transmission points and their respective scheduling for different wireless devices; and
iv. Coordinated Beamforming, CoBF, where transmission points co-operate by nulling out the channel to the wireless device served by the other transmission point(s)

It is also possible to imagine combinations of these where step-like channel response is a likely outcome.

In TM10, the wireless device may be informed about which Channel State Indicator Reference Signal, CSI-RS, or Cell Reference Signal, CRS, that the wireless device may use for e.g., time and frequency synchronization. The main purpose of these signals is to determine precoders and channel quality by the UE, which will send this information back to the eNB. These reference signals may also be utilized in order for the wireless device to separate basic cell properties, e.g., delay spread, Doppler spread, Doppler shift, average gain, and average delay, from the transmission point switching assumed in a Physical Downlink Shared Channel, PDSCH, transmission. As will be seen below such cell properties may be used for selecting the channel estimation filter.

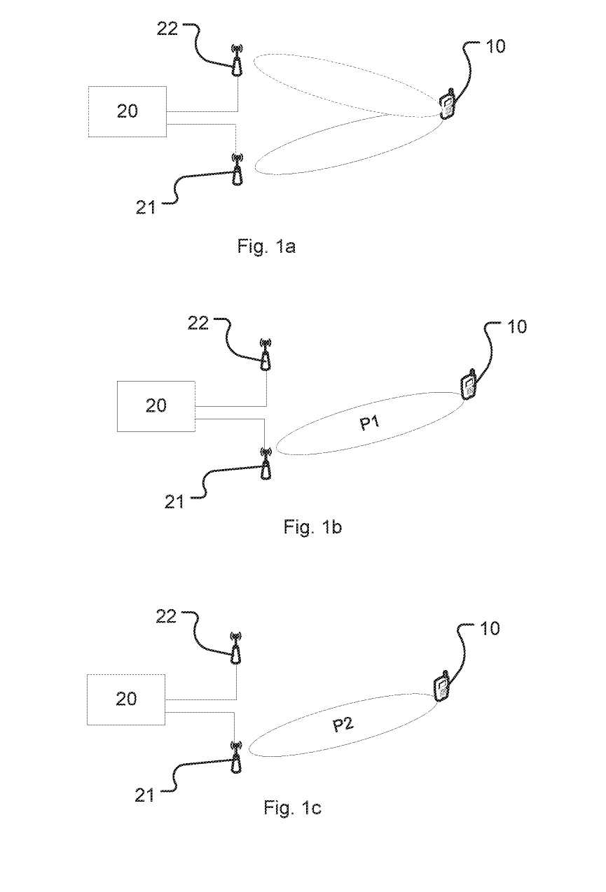

However, in certain scenarios it is possible that the transmission setup changes, even when the cell specific reference signals are unchanged. For example, in 5G radio access nodes 20 will sometimes be connected to multiple transmission points 21, 22, as illustrated in FIG. 1a. These transmission points may utilize the same multi point techniques as proposed by TM10. The transmission may also change between the different techniques. For example, the transmission might start with using only one transmission point 21, wherein the transmission from another transmission point 22 is added later, which would cause the present channel estimation filters to be outdated.

Another example is when only the precoder changes. A consequence of injecting the DMRS prior to precoding is that in the UE in TM9 or TM10 does not need to know the precoder, only the effective channel. However, this also implies that a UE in TM9 or TM10 will not be informed about when the precoder is changed or not. This is the reason why, in the present version of TM9/10 the channel estimation filtering across subframes cannot be used, since there is no way of knowing when the filter output is corrupt from obsolete precoder or channel data which is the case when the precoder or transmission changes. Hence, a radio access node 20 might transmit to wireless device from transmission point 21 using a precoder P1, see FIG. 1b. However, the radio access node might, due to e.g., changed load in the cell, need to change precoder in order not to interfere with other transmissions in the vicinity, as illustrated in FIG. 1c. Such a change would also cause the channel estimation filters to be outdated.

In other words, both in LTE and in future 5G systems, it might happen that the precoder or transmission points changes, without the UE being aware of it. From the UE perspective, there is no difference from changing a precoder in the same transmission point (since this changes the effective channel by changing the precoder) and changing transmission points (since this changes at least the channel, likely also the precoder). Within disclosure, any change that change the channel will be referred to as a change in transmission setup.

In case of inter-subframe channel estimation filtering, a change of transmission setup, implies that the change will not appear immediately since the filter states are dominated by the previous precoder. However, while that effect wears off as more reference symbols with the new precoder is inserted into the channel filter, during the transient when reference symbols with both old and new precoders are present, the demodulation will likely be erroneous.

As described above, reference symbol filtering has the advantage that it is possible to obtain better (more accurate) channel estimates, in turn resulting in higher throughputs. Hence, it is desirable to do also in TM 9/10 although for reasons explained above presently it is impossible.

Hence, in order to properly utilize these techniques involving transmission setup changes, in combination with increased performance achieved by channel estimation filtering, it is necessary for the wireless device to know when to disqualify an existing channel estimate, and when not to.

Hence, example of transmission setup changes are precoder change within a transmission point, or entire transmission point, changes as comprised within the scope of CoMP, DPS and JT described above. The proposed technique covers the case of multiple quasi co-located transmission points where the same delay spread, Doppler spread, Doppler shift, average gain, and average delay etc. may be assumed, typically a mall or stadium scenarios, see for example 3GPP TSG-RAN E-UTRA Physical Layers Procedures, TS 36.213, Sec. 7.1.9-10.

The disclosure proposes a protocol for signaling from a present transmission point to the wireless device that the channel conditions of the present transmission setup are about to change and that present channel estimation filters are to be invalidated. Hence, an action in form of a channel estimation filter reset or a channel estimation filter change is required in order to be able to receive data correctly in the future.

A compact but less informative way of doing this is to only order the wireless device to make a reset of the present channel estimation filter. A slightly more profligate way would also include an index of which cell will be the next transmitter in order for the wireless device to retrieve or compute a channel estimation filter for the new transmission setup, should it exist.

Hence, the proposed technique enables using channel estimation filtering for improved channel estimates, even in situations when there are transmission setup changes.

### Example Operations

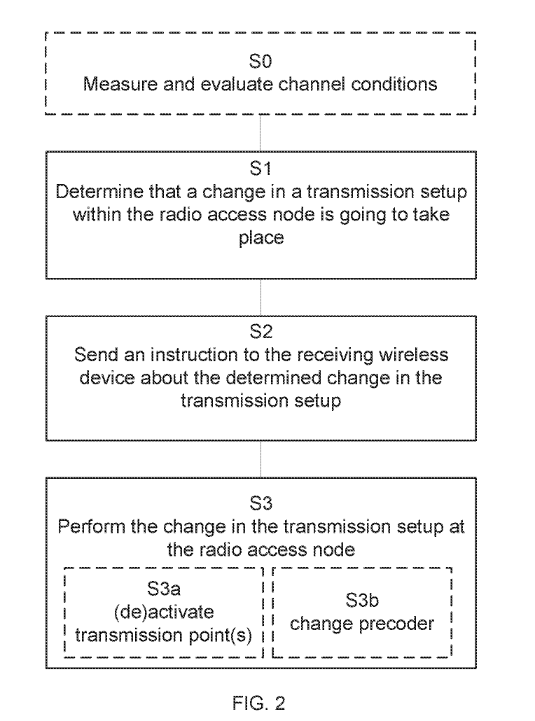

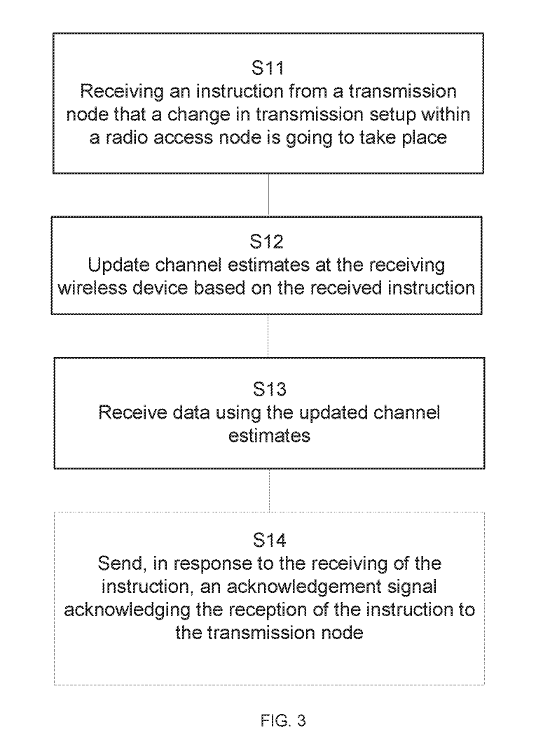

The proposed methods will now be described in more detail referring to FIG. 2 and FIG. 3. It should be appreciated that FIG. 2 and FIG. 3 comprise some operations and modules which are illustrated with a solid border and some operations and modules which are illustrated with a dashed border. The operations and modules which are illustrated with solid border are operations which are comprised in the broadest example embodiment. The operations and modules which are illustrated with dashed border are example embodiments which may be comprised in, or a part of, or are further embodiments which may be taken in addition to the operations and modules of the broader example embodiments. It should be appreciated that the operations do not need to be performed in order. Furthermore, it should be appreciated that not all of the operations need to be performed. The example operations may be performed in any order and in any combination.

FIG. 2 illustrates a method for facilitating channel estimation in a receiving wireless device, the method being performed by a wireless device 10 in a wireless communication network such as the system of FIGS. 1a to 1c. The method could be performed any time e.g., when the wireless device is connected to a radio access node and when the transmission setup at the radio access node changes. The purpose if that the radio access node informs a wireless device about coming transmission changes, such that the wireless device can adapt channel estimation filtering accordingly.

The method comprises determining S1 that a change in a transmission setup within the radio access node is going to take place. A change in a transmission setup is a change that will impact the channel estimate at the receiving node, but wherein the rest of the transmission will continue as before. In other words, the radio access node realizes due to e.g., changed cell load or changed channel conditions that the transmission setup needs to be changed. Hence, change in a transmission setup within the radio access node does not refer to a handover, where the wireless device moves between serving cells, but to a situation, where the transmission within a “cell” or “macro cell” changes. However, such a change might involve several transmission points or micro cells. Hence, the expression “change in a transmission setup within the radio access node”, refers to a transmission change that only affects the radio access node, or small nodes (micro-, pico-, nano-nodes) controlled by the radio access node.

The proposed method is a protocol for information exchange between a radio access node and a receiving wireless device relating to changing channel conditions. In order to do so, the radio access node must first identify that a change is going to take place, e.g., by analyzing signal conditions, such as RSSI, BLER or CSI information fed back from the wireless device, or in TDD estimate the channel in the uplink and make use of channel reciprocity, or from higher layer information, and from that concluding that the preferred transmission setup has changed.

Hence, according to some aspects, the method comprises measuring and evaluating S0 channel condition. Then the determining S1 comprises determining that a change in a transmission setup within the radio access node is going to take place, based on the evaluation. According to some aspects, the measured channel conditions are at least one of; Reference Signal Received Power, RSRP, Reference Signal Received Quality, RSRQ, Received Signal Strength to Interference, RSSI, BLock Error Rate, BLER, Bit Error Rate, BER, Channel State Information, CSI, provided by the wireless device and channel estimates derived from performed on the uplink channel.

A change in transmission setup may involve e.g., a change in precoder or a change in transmission points to also involving a second transmission point. Stated differently, according to some aspects, when the radio access node is configured to transmit data from multiple transmission points, the determined S1 change in transmission setup comprises a change in transmission point setup within the radio access node. According to some aspects, the determined S1 change in transmission setup comprises a change in precoder at the radio access node.

Following that, the transmission point instructs the wireless device that a transmission setup change will take place. Stated differently, the method further comprises sending S2 an instruction to the receiving wireless device about the determined change in the transmission setup. An instruction refers to one or more bits or a message carrying information. Hence the instruction is a new message or something that can be included in existing messages. In one embodiment this instruction may be one bit indicating that a change will take place whereas in another embodiment the instruction may be performed by use of a change counter such that one or more of the least significant bits of the counter are transmitted.

In one embodiment the instruction to the wireless device may comprise an indication that the existing channel estimation filters or channel estimation filter states will be obsolete whereas in another embodiment the instruction may also comprise information regarding the new transmission setup. In other words, the instruction comprises an indicator indicating that a change will take place or information about the change. The information is in one embodiment precoder information whereas in another embodiment it may also be the transmission point identity.

According to some aspects, the instruction is sent through a control channel and/or wherein the instruction is sent as a message on a layer higher than the control channel. In principle the instruction might be provided in any layer as long as the information is provided in time. The information might also be implicitly included in other signaling.

According to some aspects, the instruction comprises one or more change bits and/or one or more of the least significant bits of a change counter. A Least Significant Bit, LSB, change counter is used for the receiver to be able to distinguish between a number of consecutive states, in this case between a number of most recent resets. The states can be implemented as a counter which is reset to zero when it reached maximum number of states. At a transmission setup change the counter is increased and the value of the counter is transmitted to the wireless device. If the wireless device receives a new counter value that is more than one step higher than the previously counter value it received the device knows that it has missed a signaling of the counter. This is advantageous since the receiver is able to detect a missed reset signal by realizing a state change has occurred.

Finally, the transmission point itself makes the change of transmission setup, which in one embodiment may be a change of precoder whereas in another embodiment may be a change in both precoder and serving transmission point or transmission points. In other words, the method further comprises performing S3 the change in the transmission setup at the radio access node. According to some aspects, performing S3 the change comprises at least one of activating or deactivating one or more transmission points within the radio access node and changing precoder in the radio access node.

The disclosure provides a corresponding method in the receiving wireless device, which will now be described referring to FIG. 3. The disclosure provides a method for channel estimation, which is performed in a receiving wireless device that receives an instruction from a radio access node in accordance with the method described above.

On the wireless device side, the protocol comprises the steps of receiving an instruction that a transmission setup change will occur. The method comprises receiving S11 an instruction from a radio access node that a change in transmission setup within a radio access node is going to take place. According to some aspects, the instruction comprises an indicator indicating that a change will take place. According to some aspects, the instruction comprises information about the change. According to some aspects, the instruction comprises precoder information, channel estimation information, and/or transmission point setup information.

Upon receiving the instruction, the wireless device may act in order to improve its reception for the new transmission setup. Typically this involves updating the channel estimation procedure in accordance with the changed transmission setup. In one embodiment such an action may involve changing the channel estimation filters, whereas in yet another embodiment it may also involve resetting the states of channel estimation filters used to provide an improved channel estimate. Stated differently, the method further comprises updating S12 channel estimates and/or channel filter states and/or channel estimation filter coefficients at the receiving wireless device based on the received instruction.

According to some aspects, the updating S12 comprises initiating or ending reception from one or more transmission points. In other words, the wireless device performs actions needed to change from which transmission points it should receive data. Typically, the channel properties change when a transmission point is changed, added or removed. The channel estimation filter is selected based on channel parameters such as estimated delay spread, Doppler spread, SNR etc. If the transmission point is changed, then also the channel estimation filter itself may need to change due to one or more of the above parameters may have changed. The parameters then needs to be re-calculated using CRS, CSI-RS or similar.

There are several ways for a radio access node to change the transmission setup affecting the dimensions of the channel matrix. Changing the dimensions of the channel matrix also implies a change in the number of filters needed. The radio access node might change from one transmission point to another. Then no change in the size of the estimated channel matrix occurs but the states/estimates need to be reset. The radio access node might add a transmission point but not add any transmission layer. Then also no change in the size of the estimated channel matrix occurs, but existing states/estimates may need a reset. Alternatively the radio access node may add a transmission point and add a layer. Then the existing channel estimates and its corresponding filter states may be kept, but new rows need to be introduced as well.

According to some aspects, the updating S12 comprises changing or resetting the channel estimation filters. According to some aspects, the updating S12 comprises resetting states of presently used channel estimation filters. This might be implemented by storing the old channel estimates and or filter states to memory and/or loading previous channel estimates or filter states from memory, in order to obtaining a more precise channel estimate. Yet another embodiment will reset the CSI estimation filter and states, e.g., SNR, Doppler, delay spread, frequency offset, timing offset etc.

Following the instruction about the updated transmission setup, the radio access node transmits data in accordance with the new transmission setup. Hence, the method further comprises receiving S13 data from the radio access node using the updated channel estimates. By enabling the wireless device to update its channel estimates the risk for channel estimation errors decreases and performance is improved.

The wireless device may transmit an acknowledgement signal acknowledging the reception of the instruction. According to some aspects, the method comprises sending S14, in response to the reception of the instruction, a message acknowledging the reception of the instruction to the radio access node.

Example Node Configuration

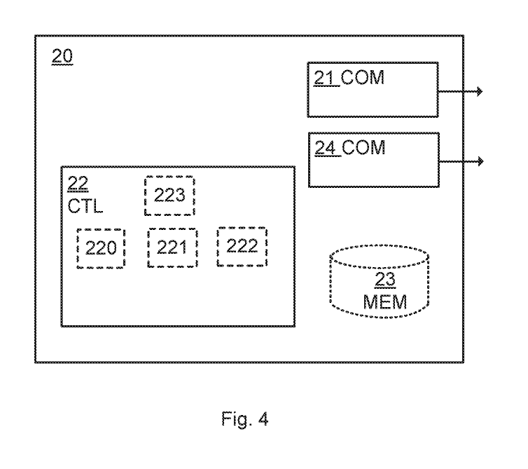

Turning now to FIG. 4, a schematic diagram illustrating some modules of an example embodiment of a radio access node in a wireless communication network being configured for configured for facilitatin

g channel estimation in a receiving wireless device.

The radio access node 20 is typically a radio access node or base station, such as an eNodeB in LTE, providing wireless access to wireless devices within one or more areas referred to as cells. The radio access node is e.g., a macro base station in a heterogeneous network controlling multiple micro base stations. The radio access node is configured to implement the methods described in relation to FIG. 2.

The radio access node 20 comprises a radio communication interface (i/f) 21 configured for communication with wireless devices 10. The wireless communication interface 21 is arranged for wireless communication with other radio access nodes within range of the radio access node 20. The radio communication interface 21 may be adapted to communicate over one or several radio access technologies. If several technologies are supported, the node typically comprises several communication interfaces, e.g., one WLAN or Bluetooth communication interface and one cellular communication interface. The radio communication interface is according to some aspect transmitting data from multiple transmission points. Parts of the radio communication interface may then be distributed to the transmission points.

As shown in FIG. 4, the radio access node 20 according to some aspects comprises a network communication interface 24. The network communication interface 24 is configured for communication with other radio access nodes e.g., in a core network. This communication is often wired e.g., using fiber. However, it may as well be wireless.

The radio access node 20 comprises a controller, CTL, or a processing circuitry 22 that may be constituted by any suitable Central Processing Unit, CPU, microcontroller, Digital Signal Processor, DSP, etc. capable of executing computer program code. The computer program may be stored in a memory, MEM 23. The memory 23 can be any combination of a Random Access Memory, RAM, and a Read Only Memory, ROM. The memory 23 may also comprise persistent storage, which, for example, can be any single one or combination of magnetic memory, optical memory, or solid state memory or even remotely mounted memory. According to some aspects, the disclosure relates to a computer program comprising computer program code which, when executed, causes a wireless device to execute the methods described above and below. According to some aspects the disclosure pertains to a computer program product or a computer readable medium holding said computer program.

The processing circuitry 22 is configured to cause the radio access node 20 to determine that a change in a transmission setup within the radio access node is going to take place, to send an instruction to the receiving wireless device about the determined change in the transmission setup, and to perform the change in the transmission setup at the radio access node.

According to some aspects, the radio access node is configured to transmit data from multiple transmission points, and then the change in transmission setup is a change in change in transmission point setup within the radio access node.

According to some aspects, the change in transmission setup is a change in change in transmission point setup within the radio access node.

According to some aspects, the instruction comprises at least one of: an indicator indicating that a change will take place and information about the change.

According to some aspects, the processing circuitry is configured to cause the radio access node to measure and evaluate channel conditions, and to determine that a change in a transmission setup within the radio access node is going to take place, based on the evaluation.

According to some aspects, the instruction comprises one or more change bits and/or one or more of the least significant bits of a change counter.

According to some aspects, the processing circuitry is configured to cause the radio access node to perform the change by activating or deactivating one or more transmission points within the radio access node and/or changing precoder in the radio access node.

According to some aspects the processing circuitry 22 or the radio access node 20 comprises modules configured to perform the methods described above. The modules are implemented in hardware or in software or in a combination thereof. The modules are according to one aspect implemented as a computer program stored in a memory 23 which run on the processing circuitry 22.

According to some aspects, radio access node or the processing circuitry 22 comprises an estimator 220 configured to cause the radio access node to transmit, to measure and evaluating channel conditions.

According to some aspects, radio access node or the processing circuitry 22 comprises a determiner 221 configured to cause the radio access node to determine that a change in a transmission setup within the radio access node is going to take place.

According to some aspects, radio access node or the processing circuitry 22 comprises a sender 222 configured to cause the radio access node to send an instruction to the receiving wireless device about the determined change in the transmission setup.

According to some aspects, radio access node or the processing circuitry 22 comprises a performer 223 configured to cause the radio access node to perform the change in the transmission setup at the radio access node.

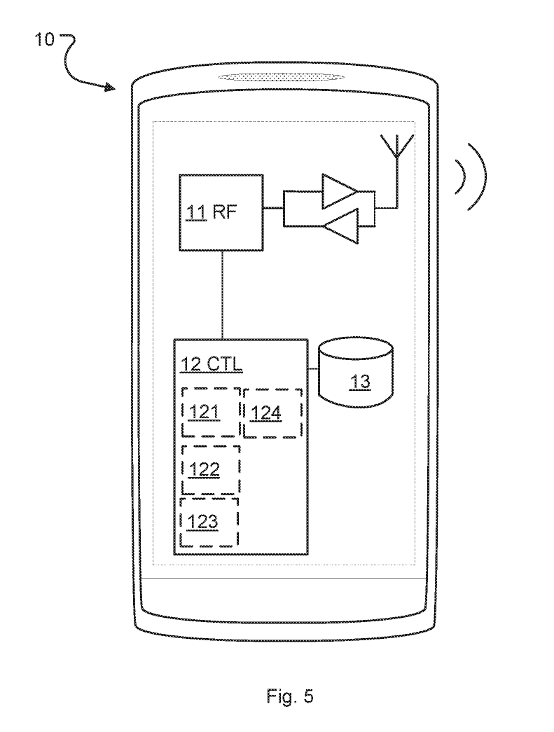

Turning to FIG. 5, a schematic diagram illustrating some modules of an example embodiment of a wireless device being configured for channel estimation will now be briefly described. The wireless device is configured to implement the methods described in relation to FIG. 3.

A “wireless device” as the term may be used herein, is to be broadly interpreted to include a radiotelephone having ability for Internet/intranet access, web browser, organizer, calendar, a camera (e.g. Video and/or still image camera), a sound recorder (e.g., a microphone), and/or Global Positioning System, GPS, receiver; a Personal Communications System, PCS, user equipment that according to some aspects combine a cellular radiotelephone with data processing; a Personal Digital Assistant, PDA, that can include a radiotelephone or wireless communication system; a laptop; a camera (e.g. Video and/or still image camera) having communication ability; and any other computation or communication device capable of transceiving, such as a personal computer, a home entertainment system, a television, etc.

As shown in FIG. 5, the wireless device 10 comprises a radio communication interface or radio circuitry 11 configured to receive and transmit any form of communications or control signals within a network. It should be appreciated that the radio circuitry 11 is according to some aspects comprised as any number of transceiving, receiving, and/or transmitting units or circuitry. It should further be appreciated that the radio circuitry 11 may e.g., be in the form of any input/output communications port known in the art. The radio circuitry 11 e.g. Comprises RF circuitry and baseband processing circuitry (not shown).

The wireless device 10 according to some aspects further comprises at least one memory unit or circuitry 13 that is in communication with the radio circuitry 11. The memory 13 may e.g., be configured to store received or transmitted data and/or executable program instructions. The memory 13 is e.g. configured to store any form of filter data. The memory 13 may e.g., be any suitable type of computer readable memory and may e.g., be of volatile and/or non-volatile type

The wireless device 10 further comprises processing circuitry 12 which is configured to cause the wireless device receive, using the communication interface 11, an instruction from a radio access node that a change in transmission setup within a radio access node is going to take place, update channel estimates and/or channel filter states and/or channel estimation filter coefficients at the receiving wireless device at the receiving wireless device based on the received instruction, and receive data using the updated channel estimates.

The processing circuitry 12 is e.g., any suitable type of computation unit, e.g., a microprocessor, Digital Signal Processor, DSP, Field Programmable Gate Array, FPGA, or Application Specific Integrated Circuit, ASIC, or any other form of circuitry. It should be appreciated that the processing circuitry need not be provided as a single unit but is according to some aspects provided as any number of units or circuitry.

The controller, CTL, or processing circuitry 12 is e.g., constituted by any suitable type of computation unit, e.g., a microprocessor, Central Processing Unit, CPU, microcontroller, Digital Signal Processor, DSP, Field Programmable Gate Array, FPGA, or Application Specific Integrated Circuit, ASIC, or any other form of circuitry capable of executing computer program code. The computer program is e.g., stored in a memory, MEM, 13. The memory 13 can be any combination of a Random Access Memory, RAM, and a Read Only Memory, ROM. The memory 13 in some situations also comprise persistent storage, which, for example, can be any single one or combination of magnetic memory, optical memory, or solid state memory or even remotely mounted memory. It should be appreciated that the processing circuitry need not be provided as a single unit but is according to some aspects provided as any number of units or circuitry. According to some aspects, the disclosure relates to a computer program comprising computer program code which, when executed, causes a wireless device to execute the methods described above and below.

According to some aspects, the processing circuitry is configured to cause the wireless device to send, in response to the reception of the instruction, a message acknowledging the reception of the instruction to the radio access node.

According to some aspects, the instruction comprises an indicator indicating that a change will take place and/or information about the change.

According to some aspects, the instruction comprises precoder information, channel estimation information, and/or transmission point setup information.

According to some aspects, the processing circuitry is configured to update the channel estimates comprises initiating or ending reception from one or more transmission points, changing or resetting the channel estimation filters and/or resetting states of presently used channel estimation filters.

According to some aspects the processing circuitry 12 or the wireless device 10 comprises modules configured to perform the methods described above. The modules are implemented in hardware or in software or in a combination thereof. The modules are according to one aspect implemented as a computer program stored in a memory 13 which run on the processing circuitry 12.

According to some aspects the wireless device 10 or the processing circuitry 12 comprises a first receiver module 121 configured to cause the wireless device to receive an instruction from a transmission node that a change in transmission setup within a radio access node is going to take place.

According to some aspects the wireless device 10 or the processing circuitry 12 comprises an updater 122 configured to cause the wireless device to update channel estimates and/or channel filter states and/or channel estimation filter coefficients at the receiving wireless device at the receiving wireless device based on the received instruction.

According to some aspects the wireless device 10 or the processing circuitry 12 comprises a second receiver module 123 configured to receive data using the updated channel estimates.

According to some aspects the wireless device 10 or the processing circuitry 12 comprises a sender 124 configured to send, in response to the receiving of the instruction, an acknowledgement signal acknowledging the reception of the instruction to the transmission node.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory, ROM, Random Access Memory, RAM, compact discs, CDs, digital versatile discs, DVD, etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1-26. (canceled)

27. A method, performed within a radio access node in a wireless communication network, for facilitating channel estimation in a receiving wireless device, the method comprising:
determining that a change in a transmission setup within the radio access node is going to take place;
sending an instruction to the receiving wireless device about the determined change in the transmission setup; and
performing the change in the transmission setup at the radio access node.

28. The method of claim 27, wherein the radio access node is configured to transmit data from multiple transmission points, and wherein the determined change in transmission setup comprises a change in transmission point setup within the radio access node.

29. The method of claim 27, wherein the determined change in transmission setup comprises a change in precoder at the radio access node.

30. The method of claim 27, wherein the instruction comprises at least one of: an indicator indicating that a change will take place and information about the change.

31. The method of claim 27, comprising:
measuring and evaluating channel conditions; and
wherein the determining comprises determining that a change in a transmission setup within the radio access node is going to take place, based on the evaluation.

32. The method of claim 31, wherein the measured channel conditions are at least one of:
Received Signal Strength to Interference (RSSI);
BLock Error Rate (BLER);
Bit Error Rate (BER);
Reference Signal Received Power (RSRP);
Reference Signal Received Quality (RSRQ);
Channel State Information (CSI) provided by the wireless device; and
channel estimates.

33. The method of claim 27, wherein the instruction is sent through a control channel and/or wherein the instruction is sent as a message on a layer higher than the control channel.

34. The method of claim 27, wherein the instruction comprises one or more change bits and/or one or more of the least significant bits of a change counter.

35. The method of claim 27, wherein performing the change comprises at least one of:
activating or deactivating one or more transmission points within the radio access node; and
changing precoder in the radio access node.

36. A method, performed in a receiving wireless device in a wireless communication network, for channel estimation, the method comprising:
receiving an instruction from a radio access node that a change in transmission setup within a radio access node is going to take place,
updating channel estimates and/or channel filter states and/or channel estimation filter coefficients at the receiving wireless device at the receiving wireless device based on the received instruction; and
receiving data from the radio access node using the updated channel estimates.

37. The method of claim 36, comprising:
sending, in response to the reception of the instruction, a message acknowledging the reception of the instruction to the radio access node.

38. The method of claim 36, wherein the instruction comprises an indicator indicating that a change will take place and/or information about the change.

39. The method of any of claims claim 36, wherein the instruction comprises any one or more of:
precoder information;
channel estimation information; and
transmission point setup information.

40. The method of claim 36, wherein updating comprises any one or more of:
initiating or ending reception from one or more transmission points;
changing or resetting the channel estimation filters; and
resetting states of presently used channel estimation filters.

41. A radio access node, in a wireless communication network, configured for facilitating channel estimation in a receiving wireless device, the radio access node comprising:
a radio communication interface; and
processing circuitry configured to cause the radio access node:
to determine that a change in a transmission setup within the radio access node is going to take place,
to send an instruction to the receiving wireless device about the determined change in the transmission setup, and
to perform the change in the transmission setup at the radio access node.

42. The radio access node of claim 41, wherein the radio access node is configured to transmit data from multiple transmission points, and wherein the change in transmission setup is a change in change in transmission point setup within the radio access node.

43. The radio access node of claim 41, wherein the change in transmission setup is a change in change in transmission point setup within the radio access node.

44. The radio access node of claim 41, wherein the instruction comprises at least one of: an indicator indicating that a change will take place and information about the change.

45. The radio access node of claim 41, wherein the processing circuitry is configured to cause the radio access node to:
measure and evaluate channel conditions, and
determine that a change in a transmission setup within the radio access node is going to take place, based on the evaluation.

46. The radio access node of claim 41, wherein the instruction comprises one or more change bits and/or one or more of the least significant bits of a change counter.

47. The radio access node of claim 41, wherein the processing circuitry is configured to cause the radio access node to perform the change by any one or more of:
activating or deactivating one or more transmission points within the radio access node; and
changing precoder in the radio access node.

48. A wireless device in a wireless communication network, configured for channel estimation, the wireless device comprising:
a communication interface, and
processing circuitry configured to cause the wireless device to:
receive, using the communication interface, an instruction from a radio access node that a change in transmission setup within a radio access node is going to take place;
update channel estimates and/or channel filter states and/or channel estimation filter coefficients at the receiving wireless device at the receiving wireless device based on the received instruction; and
receive data using the updated channel estimates.

49. The wireless device of claim 48, wherein the processing circuitry is configured to cause the wireless device to:
send, in response to the reception of the instruction, a message acknowledging the reception of the instruction to the radio access node.

50. The wireless device of claim 48, wherein the instruction comprises an indicator indicating that a change will take place and/or information about the change.

51. The wireless device of claim 48, wherein the instruction comprises any one or more:
precoder information;
channel estimation information; and
transmission point setup information.

52. The wireless device of claim 48, wherein the processing circuitry is configured to update the channel estimates by initiating or ending reception from one or more transmission points, changing or resetting the channel estimation filters and/or resetting states of presently used channel estimation filters.
